(19) United States
(12) Patent Application Publication
(10) Pub. No.: US 2020/0093686 A1
(43) Pub. Date: Mar. 26, 2020

(54) LYMPHATIC WAVE SYSTEM

(71) Applicant: Giuliano Fiumani, Santa Monica, CA (US)

(72) Inventor: Giuliano Fiumani, Santa Monica, CA (US)

(21) Appl. No.: 16/140,946

(22) Filed: Sep. 25, 2018

(51) Int. Cl. A61H 23/02

(52) U.S. Cl. CPC A61H 23/0254; A61H 23/006; A61H 2209/00

(57) ABSTRACT

The invention relates to the field of physical health and more particularly to methods and devices for effecting movement of the body in order to achieve lymphatic movement. Additionally, systems and devices are disclosed for circulating lymph through the body.

### BACKGROUND

The main way the human body cleans itself and fights infections is through the lymphatic system. The lymph is a component of the blood. It is pumped out to the tissues in the blood stream and it soaks through the capillary walls into tissues to bring nutrients to cells and removes wastes and cleans the tissues. While in the tissue this fluid is referred to as “interstitial fluid.” As lymph moves though the tissues it takes away metabolic wastes, toxins, allergens, pathogens like bacteria, and viruses, or any foreign protein. If there is any foreign invader present, the lymph is the system through which it will be cleared from tissue. As the lymph moves, it brings these foreign proteins to lymph nodes where it can be filtered, and pathogens and foreign proteins destroyed. Once outside the blood stream, the lymph does not have the heart or the smooth muscles of blood vessels to move it along. It only moves through movement of the body and muscle contraction.

In addition, cells of the immune system travel through the lymph. These include B lymphocytes, macrophages, and dendrite cells, which are the first to come into contact with a foreign protein and initiate an immune response. These cells depend on the movement of lymph to do their jobs. They will not ever be able find a foreign protein, eliminate it, or even register that an infection has commenced unless the body is moving and the lymph is circulating through tissues. Without movement, the immune system is crippled and does not work. Diminished circulation can also result in blood clots and condition such as edema, which is an accumulation of excess fluid in certain tissues of the body.

Existing treatment methodologies for conditions such as edema include compression stockings or devices, which can be uncomfortable or ineffective, leading to reduced patient compliance.

Muscle manipulation devices have also been proposed, but many of these require a complex configuration of straps and belts to immobilize the patient or attach a patient to a device. Many users find the confinement required by these systems to be uncomfortable or even stressful, which can reduce patient compliance.

Many prior art devices also provide manipulation of only a limited portion of the lower extremities, such as the feet or ankle joint, and neglecting the benefits that can be obtained by manipulating the entire leg.

Accordingly, there is a need for a system and method for promoting the circulation of lymph in the body that addresses the foregoing limitations.

### BRIEF DESCRIPTION OF THE DRAWINGS

The features and advantages of the present disclosure will be more fully understood with reference to the following detailed description when taken in conjunction with the accompanying figures, wherein:

FIG. 1 depicts a top view of an exemplary lymphatic wave system;

FIG. 2 depicts a side view of the exemplary lymphatic wave system of FIG. 1 with the legs of a patient shown in dashed lines;

FIG. 3 depicts a perspective view of an exemplary lymphatic wave system; and

FIG. 4 depicts a human body and the associated lymph vessels and duct lines.

FIG. 5 depicts a prototype embodiment of an exemplary lymphatic wave system.

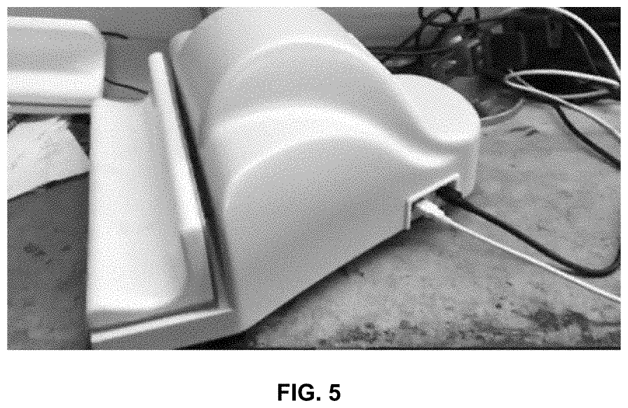

### SUMMARY

In embodiments of the invention, a system for manipulating the extremities and promoting circulation of lymph in a patient includes: (1) a substrate comprising a substantially planar mounting board; (2) a foot holder configured to receive at least a portion of a least one foot of a patient; (3) a guiding rail attached to said substrate and configured to ensure linear movement of said foot holder relative to said substrate; (4) a sliding bracket connected to said foot holder and in slidable communication with said guiding rail; (5) a motor mounted on said substrate and in communication with a plurality of linkages attached to said sliding bracket and having an oscillation speed, wherein said motor and said linkages provide linear movement of said sliding bracket and said foot holder relative to said substrate, said linear movement having an amplitude; (6) a memory configured to receive real-time session data; and (7) a microprocessor operatively coupled to said motor and said memory, and configured to dynamically adjust said oscillation speed and amplitude in response to a data object to achieve the most efficient oscillation movement.

In embodiments of the invention, the motor may be an actuator motor.

In embodiments of the invention, the patient may not physically bound to the system during use such that the knees of the patient are free to bend.

In embodiments of the invention, the foot holder may be contoured, or may be detachable. In further embodiments of the invention, a support bracket may be interposed between the foot holder and the sliding bracket.

In embodiments of the invention, the data object may be session data, or may be health metric data sourced from a biological sensor attached to the system.

In embodiments of the invention, the microprocessor may further configured to dynamically adjust the oscillation speed and amplitude in response to the patient's bounce or rebound from each cycle of the sliding bracket and the foot holder. Embodiments of the invention may be hysteric and oscillation speed and amplitude are adjusted gradually in response to a prior system state.

In embodiments of the invention, a user interface may be provided to enable entry of patient information, which interface may or may not be physically integrated with the system.

In embodiments of the invention, a method may be provided for manipulating the extremities and promoting circulation of lymph in a patient, which method includes the steps of: (1) providing a device as described above; (2) receiving, at a sensor coupled to the device, a data object representing the patient's bounce or rebound from each cycle of said sliding bracket and said foot holder; and (3) dynamically adjusting the oscillation speed and amplitude in response to the data object to achieve the most efficient oscillation movement.

### DETAILED DESCRIPTION

The exemplary embodiments are depicted for purposes of illustration and dimensions and/or proportions may vary.

Devices may comprise means for a mechanical component for transmitting torque and rotation, usually used to connect other components, such as a drive shaft with a belt and or a motorized drive, where the mechanical component is configured to allow full body oscillation to cycle lymph through the body. The device may further comprise one or more sensors, placed within the device in order to detect an affect that is caused by the rebound of the body and accordingly estimate a user's weight. Additionally, the device may comprise a processor and memory, where the processor may be configured to determine the oscillation frequency based on amplitude and or weight of the user. Via the processor and memory in communication with the sensors, the device may collect real-time data and adjust the settings, i.e., speed, amplitude, frequency, in order to achieve the most efficient oscillation movement, thereby facilitating the body's immune response to any foreign invaders.

The device, in its several embodiments, may provide full body oscillation causing a gentle rocking as the user, e.g., patient, lies face up or supine and parallel to a local plane. Alternatively, the patient may lie face down with the toes pointed toward the floor. The movement may then stimulate the body's natural physiology to eliminate edema, accelerate healing from injuries or surgeries, fight infections, and reduce the need for antibiotics and pain medication. The device may provide movement to circulate the lymph, facilitate the function of the immune system, and reduce swelling, inflammation and edema. In an injury, blood rushes out to tissues in an inflammatory state but usually the blood vessels themselves have not been broken and the swelling is technically edema, the saturation of lymph or interstitial fluid in the tissues.

Even if there are broken blood vessels and discoloration most of that extra volume is not blood cells but the fluid that comes with it. Once outside the blood vessels, this fluid will not move without movement. Accordingly, movement is the key to bringing down that swelling.

In one embodiment, as the body puts an external force on the system, the exemplary device may adjust and oscillate with greater amplitude at a specific preferential frequency. Increase of amplitude as damping decreases and frequency approaches resonant frequency of a driven damped simple harmonic oscillator. Accordingly, by using positional and/or electric current monitoring of the motor and sliding mechanism, the lymphatic wave system may determine the natural resonant frequency of the user in the supine position or prone position.

Additionally, via using a microcontroller, the lymphatic wave system may automatically adjust to the ideal frequency and excursion of the foot-bed.

In one embodiment, an actuator component may be used as the component responsible for moving or controlling the foot holder of the lymphatic wave system. The actuator may be a linear electric actuator that may require a control signal and a source of energy. The exemplary microcontroller may use control signals that use relatively low energy and may be electric voltage or current, pneumatic or hydraulic pressure. The exemplary linear electric actuator is one example of a number of different class drive systems that may be used in the lymphatic wave system.

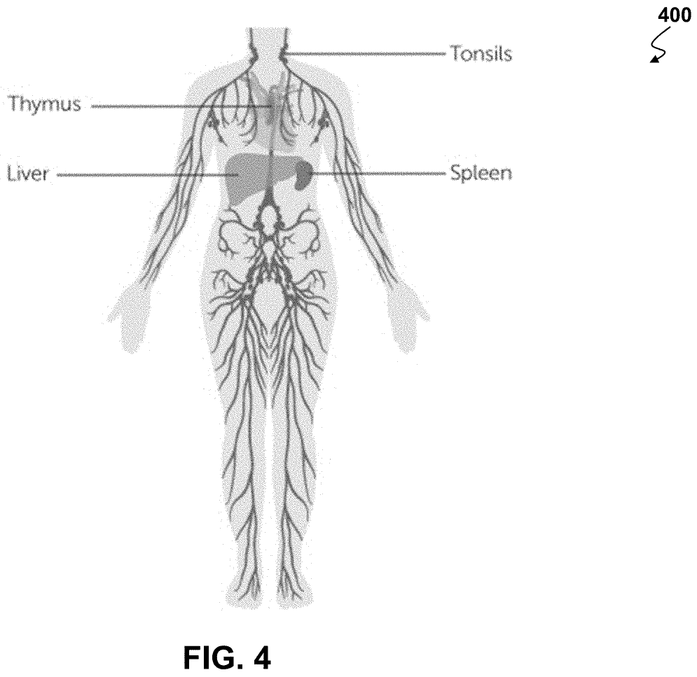

The exemplary device may move the body so that the lymph begins to cycle and drain to the lymph nodes and eventually through to the thoracic duct and back into the blood stream. That is, the device may provide comfortable passive movement that will move the lymph, clean the tissues, and reduce swelling. The device may provide movement which is not only comfortable and relaxing for the patient—the head to toe motion—but also provide movement corresponding to the way the lymph vessels lie in the body (see FIG. 4). Accordingly, the device may provide the most efficient way to move lymph, resolve inflammation and swelling, and clean the tissues of toxins, allergens, pathogens, and microbes which may cause infections.

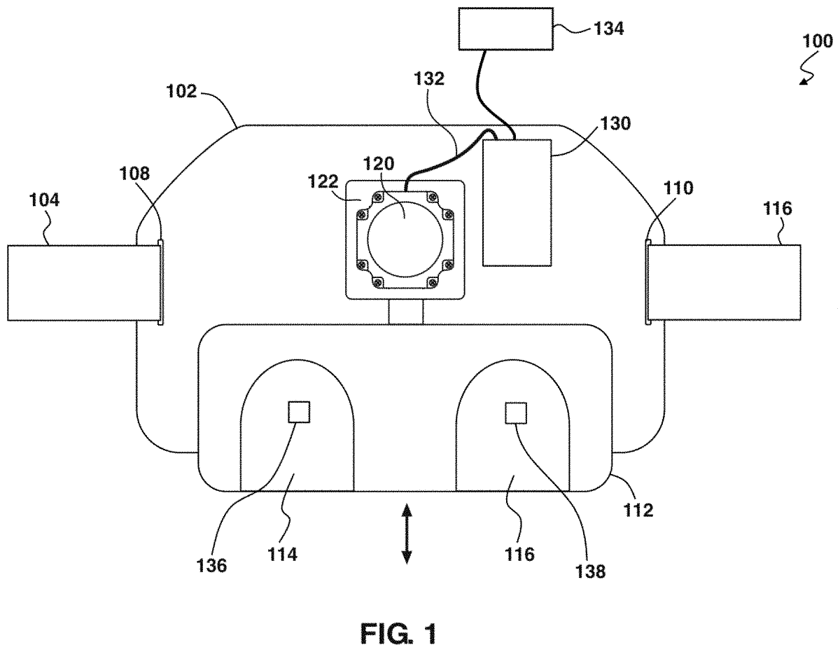

FIG. 1 depicts a top view of an exemplary lymphatic wave system 100. The system 100 may include a mounting board 102 to hold one or more components of the system 100. The mounting board 102 may be a thin board having a flat upper and lower surface. The mounting board 102 may be made from any suitable materials such as aluminum, steel, acrylic, fiberglass, metals, plastics, etc. The mounting board 102 may be placed on an end of a patient's bed and secured via one or more mounting straps 104, 106 and then secured through one or more apertures 108, 110 in the mounting board 102. The mounting straps 104, 106 may secure the mounting board 102 relative to the patient bed, or other surface. In some embodiments, the lower surface of the mounting board 102 may include surface indicia to increase friction and prevent the mounting board 102 from moving relative to the patient bed or other object on which it is placed.

The system 100 may also include a foot holder 112. The foot holder may be slidably mounted on the mounting board 102 such that the foot holder is limited in movement to a single axis 118 relative to the mounting board 102. The foot holder 112 may include one or more contours 114, 116 sized to accommodate a left and/or right foot, respectively, of a patient. In one embodiment, the foot holder 112 may be lacking any contours and solely rely on the body's natural recoil motion. The foot holder 112 may be made from foam, plastic, or any other suitable material. In some embodiments, the foot holder 112 may be detachable and replaceable with other dimensioned foot holders to accommodate a variety of patients. In other embodiments, the one or more contours 114, 116 of the foot holder 112 may be expanded or contracted, e.g., via pumping air or liquid, to accommodate patients having varying dimensions and/or needs.

A motor 120 may be mounted on the mounting board 102. The motor 120 may include a gearbox 122 and one or more linkages 124, 126, 128 to translate the rotational movement of the motor 120 into the linear movement 118 of the foot holder 112. In some embodiments, the motor 120 may be replaced by an actuator to create this linear movement.

A control box 130 may include a processor that may have an addressable memory. The control box 130 may communicate 132 with the motor 120 to set the distance and/or speed of movement 118 of the foot holder 112 relative to the mounting board 102. In some embodiments, the control box 130 may include a user interface to allow the patient and/or an operator of the system 100 to enter patient information and/or an operating mode of the system 100. Patient information may include age, weight, height, details of any prior treatments, and any medical conditions. Operating mode may include a combination of movement distance and speed of movement of the foot holder 112. In some embodiments, the control box 130 may communicate wirelessly, e.g., via Bluetooth, Wi-Fi, etc., with a mobile application for entering patient information and/or an operating mode of the system 100, or receiving information about the treatment session. The control box may be powered by a power supply 134 such as an external battery pack, wall plug, etc.

In some embodiments, the patient information and/or operating mode of the system 100 may be determined by one or more sensors 136, 138. These sensors may be used to determine a patient's weight, pulse, blood pressure, or other information that may be used to determine an ideal operating mode of the system 100. Additionally, the sensors 136, 138 may operate to or be configured to detect the adaptability, flexibility, adjustability, of fluidity, of the body in order to determine the frequency and amplitude of motion necessitated to accommodate the particular human body. The system 100 may have the ability to change and adapt, i.e., adaptability, based on the sensor readings in real-time or near real-time. In effect, a hysteresis system may be created where the dependence of the state of the system is on its history. For example, a human body may have more density than another, affecting the momentum with which it may sway back and forth, and given the pressure exerted on the sensors, depending on how fast the movement changes, the system may adjust the settings internally; without any user interaction. For example, in one embodiment, the system may plot a single component of the momentum/movement on a regular interval of time to form a loop. This history dependence may then be the basis of memory in a hard disk drive and the remanence that retains a record of the patient's previous movement in history.

The system embodiments may prevent unwanted frequent switching in the oscillation speed and hence provide a gradual increase or decrease in the movement of the human body. That is, by creating a controlled system, hysteresis may be used to filter signals and sensor readings so that the output reacts less rapidly than it otherwise would, by considering recent history. That is, the recent history may include the sensors measurements of body's bounce or rebound from each thrust of the lymphatic wave system and the momentum by which the body is driven back. Accordingly, the system may automatically and dynamically, adjust the oscillation speed through the micro controller communicating with the sensors, via, for example, interfacing through serial ports, using analog and mixed-signal sensors.

The lymphatic wave system may utilize an embedded system comprising multiple sensors to sample the environmental input as discussed above. In one embodiment, the system may use simple serial interfaces that produce digital output, which may be directly processed by the microcontroller. Some of these systems use traditional serial interfaces that are multiplexed among the sensors to provide the controllers with the structure to handle just one input at a time.

Other embodiments may use serial sensor devices that incorporate full protocol management of the input interface and that interface's methods for multi-device management. While in one embodiment, communication with sensors is digital, other embodiments may use sensors that are analog. Some exemplary analog sensors include light and IR detectors, thermocouples, touch controllers, sound and external-area motion sensors, device position and movement sensors, and temperature and pressure sensors.

Accordingly, the device may monitor that in a body, lymph is pumped out to tissues through the blood stream and then soaks through the capillary walls into the tissues. The lymph moves primarily with body movement and muscle contraction, so when one moves the body the lymph moves as well. Since lymph primarily moves when the body moves, the system may monitor movement and other factors using the exemplary sensors, and determine the effectiveness of the lymphatic wave system's current oscillation speed and dynamically adjust the oscillation speed and other adjustable attributes to achieve the best movement of the lymph.

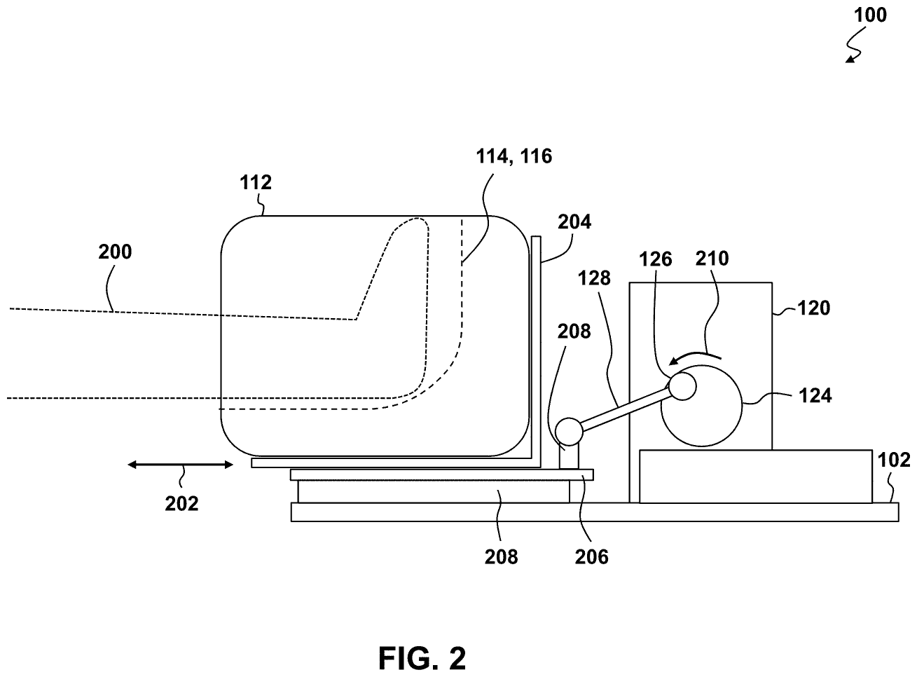

FIG. 2 depicts a side view of the exemplary lymphatic wave system 100 of FIG. 1. The legs 200 of a patient are depicted in dashed lines and are located in the contours 114, 116 of the foot holder 112. The legs 200 of the patient are moved 202 forward and backward with the movement of the foot holder 112 relative to the mounting board 102. In one exemplary embodiment, the foot holder 112 may be secured to an L-shaped bracket 204, other embodiments may not require the foot to be secured and instead depend on the plantar surface (i.e., the sole) of the foot abutting the foot holder 112. The foot holder 112 may be fixed to the L-shaped bracket by adhesives, bolts, etc. In some embodiments, the foot holder 112 may be detachably attached to the L-shaped bracket by hook and loop fasteners, magnets, etc. to accommodate foot holders 112 with differently sized and/or shaped contours 114, 116. In a preferred embodiment of the device, the legs of the patient are moved in parallel with the patient's legs bending at the knees with each stroke.

The L-shaped bracket 204 may be fixedly attached to a sliding bracket 206 and have a range of angles between the two arms. Additionally, the L-shaped bracket 2014 may be used in a way so as to include a soft material, e.g., foam, to allow for the foot's plantar surface to be secured via friction between the two surfaces. The sliding bracket 206 may be secured about a guiding rail 208. The sliding bracket 206 and guiding rail 208 may ensure a linear movement of the foot holder 112 relative to the mounting board 102. In some embodiments, the guiding rail 208 may include bearings, Teflon, or other materials to minimize friction between the sliding bracket 206 and the guiding rail 208. The sliding bracket 206 may also include a linkage mounting bracket 208 to secure one end of the one or more linkages 124, 126, 129 to the sliding bracket 206. The rotation movement of the motor 120 is translated into linear movement 202 of the foot holder 112 by the one or more linkages 124, 126, 129 and the movement of the sliding bracket 206 relative to the guiding rail 208. In embodiments, a ball bearing slide may be utilized.

The velocity profile of the stroke is a sine wave. Minimum speed at each point and maximum speed at the middle points, half way in the in and out. The velocity curve of the stroke is the same in both directions.

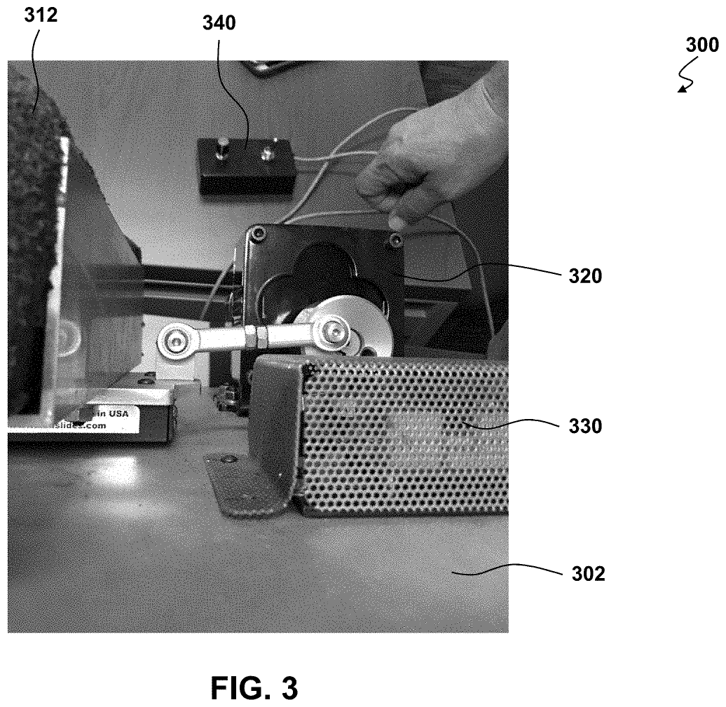

FIG. 3 depicts a perspective view of an exemplary lymphatic wave system 300. The system 300 may include a mounting board 302, a foot holder 312, a control box 330, a motor 320, and a controller 340. In embodiments of the invention a brushless DC motor may be used, preferably with an integrated drive controller and gear reducer. It should be noted that since a brushless DC motor is a constant torque device, so full power is available at any speed.

With the reducer the output shaft is specified for 5 to 150 RPM, which is the speed the slide moves at. Therefore it would be 5 to 150 full strokes out an in per minute. However, the electronics are programmed to limit the low speed to 30 per minute, a lower speed would not be beneficial. This configuration will allow to motor to reach the maximum speed of 160 at full speed.

With the reducer the output shaft is specified for 5 to 150 RPM, which is the speed the slide moves at. Therefore it would be 5 to 150 full strokes out an in per minute. However, the electronics are programmed to limit the low speed to 30 per minute, a lower speed would not be beneficial. This configuration will allow to motor to reach the maximum speed of 160 at full speed.

FIG. 4 depicts a human body and the associated lymph vessels and duct lines 400. As shown, the lymph vessels and ducts line up mostly from head to toe. In the arms and legs, the vessels run from the hands and feet toward the top of the chest. Because lymph vessels run inferiorly and superiorly—from head to toe—the most efficient way to move lymph along those vessels and get it to cycle through lymph nodes and eventually drain back through the thoracic duct at the top of the chest into circulation. That is, the lymphatic wave system may move the body in planes that include: median plane, parasagittal plane, frontal or coronal plane. Also shown are the tonsils, thymus, liver, and spleen that are all connected to the human lymph vessels. Accordingly, the system maximizes the movement of lymph by working with the body's natural anatomy and physiology.

In a prototype embodiment, a 100 W brushless DC motor was used, providing approximately ⅛ horsepower, and a 20:1 inline gear reducer. In the prototype, with the reducer the output shaft was specified for 5-150 RPM, or 5-150 full strokes out and in per minute. The system electronics were programmed to limit the low speed to 30 strokes per minute since it has been found that a lower speed would not offer therapeutic benefit. The motor used in the prototype embodiment was rated at 63 pound/inches of torque, with a fixed 1″ stroke and crank radius of 0.5″ to provide approximately 115 pound of push at the halfway point of the stroke. In the prototype embodiment, a maximum speed of 75 inches per minute (0.8 inches per second) was provided.

In the prototype embodiment, the motor control was provided with the motor. A separate 20 kHz speed control unit was utilized.

Power to the prototype embodiment was provided by a 24V DC, 120 W medically rated power supply. A display panel provided options to the user to control speed and duration.

It is contemplated that various combinations and/or sub-combinations of the specific features and aspects of the above embodiments may be made and still fall within the scope of the invention. Accordingly, it should be understood that various features and aspects of the disclosed embodiments may be combined with or substituted for one another in order to form varying modes of the disclosed invention. Further, it is intended that the scope of the present invention herein disclosed by way of examples should not be limited by the particular disclosed embodiments described above.

We claim:

1. A system for manipulating the extremities and promoting circulation of lymph in a patient, including:
a substrate comprising a substantially planar mounting board;
a foot holder configured to receive at least a portion of a least one foot of a patient;
a guiding rail attached to said substrate and configured to ensure linear movement of said foot holder relative to said substrate;
a sliding bracket connected to said foot holder and in slidable communication with said guiding rail;
a motor mounted on said substrate and in communication with a plurality of linkages attached to said sliding bracket and having an oscillation speed, wherein said motor and said linkages provide linear movement of said sliding bracket and said foot holder relative to said substrate, said linear movement having an amplitude;
a memory configured to receive real-time session data,
a microprocessor operatively coupled to said motor and said memory, and configured to dynamically adjust said oscillation speed and amplitude in response to a data object to achieve the most efficient oscillation movement.

2. The system of claim 1 wherein the motor is an actuator motor.

3. The system of claim 1 wherein the patient is not physically bound to the system during user.

4. The system of claim 1 wherein said foot holder is contoured.

5. The system of claim 1 wherein said foot holder detachable.

6. The system of claim 1 wherein a support bracket is interposed between said foot holding and said sliding bracket.

7. The system of claim 1 wherein the data object is said session data.

8. The system of claim 1 wherein said data object is health metric data sourced from a biological sensor attached to the system.

9. The system of claim 1 wherein said microprocessor further configured to dynamically adjust said oscillation speed and amplitude in response to the patient's bounce or rebound from each cycle of said sliding bracket and said foot holder.

10. The system of claim 1 wherein the system is hysteric and oscillation speed and amplitude are adjusted gradually in response to a prior system state.

11. The system of claim 1 further comprising a user interface that enables entry of patient information.

12. The system of claim 11 wherein the user interface is not physically integrated with the system.

13. A system for manipulating the extremities and promoting circulation of lymph in a patient, including:
a substrate comprising a substantially planar mounting board;
a foot holder configured to receive at least a portion of a least one foot of a patient;
a guiding rail attached to said substrate and configured to ensure linear movement of said foot holder relative to said substrate;
a sliding bracket connected to said foot holder and in slidable communication with said guiding rail;
one or more sensors configured to provide patient data comprising the bounce and rebound of said foot holder during operation and the user's physical condition;
a motor mounted on said substrate and in communication with a plurality of linkages attached to said sliding bracket and having an oscillation speed, wherein said motor and said linkages provide linear movement of said sliding bracket and said foot holder relative to said substrate, said linear movement having an amplitude;
a memory configured to receive real-time patient data,
a microprocessor operatively coupled to said motor and said memory, and configured to dynamically adjust said oscillation speed and amplitude in response to said patient data to achieve the most efficient oscillation movement.

14. The system of claim 13 wherein the motor is an actuator motor.

15. The system of claim 13 wherein said extremities are not physically bound to the system during user.

16. The system of claim 13 wherein said foot holder is contoured.

17. The system of claim 13 wherein a support bracket is interposed between said foot holder and said sliding bracket.

18. The system of claim 1 wherein the system is hysteric and oscillation speed and amplitude are adjusted gradually in response to a prior system state.

19. The system of claim 1 further comprising a user interface that enables entry of patient information.

20. A method of manipulating the extremities and promoting circulation of lymph in a patient, including:
providing a device comprising: a substrate comprising a substantially planar mounting board; a foot holder configured to receive at least a portion of a least one foot of a patient; a guiding rail attached to said substrate and configured to ensure linear movement of said foot holder relative to said substrate; a sliding bracket connected to said foot holder and in slidable communication with said guiding rail; one or more sensors configured to provide patient data comprising the bounce and rebound of said foot holder during operation and the user's physical condition; a motor mounted on said substrate and in communication with a plurality of linkages attached to said sliding bracket and having an oscillation speed, wherein said motor and said linkages provide linear movement of said sliding bracket and said foot holder relative to said substrate, said linear movement having an amplitude; a memory configured to receive real-time patient data; and a microprocessor operatively coupled to said motor and said memory;
receiving, at a sensor coupled to said device, a data object representing the patient's bounce or rebound from each cycle of said sliding bracket and said foot holder; and
dynamically adjusting said oscillation speed and amplitude in response to said data object to achieve the most efficient oscillation movement.
